(19) United States
(12) Patent Application Publication
(10) Pub. No.: US 2023/0171510 A1
(43) Pub. Date: Jun. 1, 2023

(54) VISION SYSTEM FOR A MOTOR VEHICLE

(71) Applicant: ARRIVER SOFTWARE AB, Linkoping (SE)

(72) Inventor: Leif Ove LINDGREN, Linköping (SE)

(21) Appl. No.: 18/002,801

(22) PCT Filed: Jul. 15, 2020
(86) PCT No.: PCT/EP2020/070030

§ 371 Date: Dec. 21, 2022

(51) Int. Cl. H04N 23/745; G06V 20/58; H04N 23/71; G06V 10/36; H04N 5/265

(52) U.S. Cl. CPC H04N 23/745; G06V 20/58; H04N 23/71; G06V 10/36; H04N 5/265

(57) ABSTRACT

A vision system (10) for a motor vehicle comprises an imaging apparatus (11) adapted to capture images from a surrounding of the motor vehicle, and a data processing unit (14) adapted to perform image processing on images captured by said imaging apparatus (11) in order to detect objects in the surrounding of the motor vehicle. The data processing unit (14) comprises a flicker mitigation software module (33) adapted to generate a flicker mitigated current image (30′) for a current image frame by filter processing involving a captured current image (30_{N+1}) corresponding to the current image frame and at least one captured earlier image (30_{N}) corresponding to an earlier image frame.

The invention relates to a vision system for a motor vehicle, comprising an imaging apparatus adapted to capture images from a surrounding of the motor vehicle, and a data processing unit adapted to perform image processing on images captured by said imaging apparatus in order to detect objects in the surrounding of the motor vehicle.

Some light sources flicker. Example of such light sources are, e.g., LED traffic lights, LED traffic signs, LED streetlights, 50/60 Hz DC powered light sources, and vehicle headlights. Minimum frequency for traffic lights in the EU is 90 Hz. The flicker has most often a frequency that is higher than a human observer can detect, but it will result in flicker in video recordings. The flicker can give difficulties for the object detection algorithm. Flickering video is also not wanted when recording video images for, e.g., Event Data Recording (EDR) applications, dashcam applications, augmented reality applications, or when displaying video in a vehicle.

Image sensors are known which offer LED Flicker Mitigation (LFM). This technique is primarily developed to capture LED pulses from e.g. traffic lights and traffic signs. This is often implemented using a sensor with very low sensitivity. This allows for using a long exposure time, e.g. 11 ms to handle 90 Hz. However, the long exposure time will give large motion blur artefacts when driving which is typically not good for object detection algorithms. Sensors with LFM support typically also have slightly reduced night time performance. It is also difficult to implement LFM in image sensor with very small pixels. LFM does not by itself solve the issue with low flicker video from traffic lights and traffic signs since e.g. one frame can capture one LED pulse and the next image can capture two. LFM by itself does also not solve the issue with flicker banding caused when a scene is illuminated by flickering light sources. Most of the currently available sensors for automotive vision systems do not offer LFM. Forward looking vision cameras practically have image sensors without such flicker mitigation pixels.

Known cameras for motor vehicles are optimized to give images that are optimal for the object detection algorithms, which is in conflict with generating images/video that is optimal for EDR or display/dashcam/augmented reality applications.

Adapting the frame rate to the frequency of the flickering light source reduces flicker at the light source and flicker banding when a scene is illuminated by light sources of the same frequency. This typically means running at 30 fps (frames per second) in a 60 Hz country and running at 25 fps in a 50 Hz country. However, having different frame rates in different countries is not desired by the vehicle manufacturers.

It is also possible to adapt the exposure time to the frequency of the flickering light source, e.g. using 10 ms exposure time in a 50 Hz country (with 100 Hz flicker) and using 8.3 ms or 16.7 ms in a 60 Hz country. Adapting the exposure time to the frequency of light sources instead of adapting it to the illumination level of the scene gives a non-optimal compromise between SNR (signal-to-noise ratio) and motion artefacts. For a multiple exposure HDR (high dynamic range) sensor without LFM support this method only works for the long exposure time which is used for the darker signals, while bright parts of the scene will use shorter exposure times and will flicker. None of the above described two methods work for e.g. LED pulse modulated light that are not a multiple of 50 and 60 Hz.

Known camera solutions are based on a frame rate specifically tailored to cause maximum flicker between two frames for 50 Hz and 60 Hz light sources. This allows for detecting light sources that are run from the 50/60 Hz grid and separating them from vehicle light sources. It also reduces the risk of missing LED pulses from 50/60 Hz traffic lights and traffic signs in two consecutive frames at day time, since the established frame rate leads close to a 0.5 period phase shift (π phase shift) between two consecutive image frames for such frequencies.

By not using an LFM image sensor it is possible to use shorter exposure times during day and dusk, giving reduced motion blur and thus better detection performance. As a result, unprocessed camera video flickers. At day it is primarily flicker at strong light sources like low frequency LED traffic lights. At night it is primarily city scenes where streetlights are powered with 50/60 Hz. This is not an issue for an object detection algorithm, but for applications like augmented reality and dashcam.

The problem underlying the present invention is to provide a vision system effectively reducing artefacts in captured images caused by flickering light sources, and/or giving flicker free video for Event Data Recording or display/dashcam/augmented reality applications and at the same time high quality images suited for object detection algorithms.

The invention solves this problem with the features of the in-dependent claims. According to the invention, the data processing unit comprises a flicker mitigation software module adapted to generate a flicker mitigated current image for a current image frame by filter processing involving a captured current image corresponding to the current image frame and at least one captured earlier image corresponding to an earlier image frame.

The invention solves the problem with flickering video by a pure software or image processing solution. Imaging devices of the imaging apparatus, like cameras, can have a traditional image sensor without need for LED flicker mitigation support in hardware. With the invention it is possible to meet requirements of a smooth video stream without need for an image sensor having LED flicker mitigation.

According to a first basic embodiment of the invention, the flicker mitigation software module is adapted to time filter a region around a detected light source in said captured current image and said at least one captured earlier image. The solution is based on detecting light sources by detection algorithms known per se. The light sources which can be detected can include, e.g., one or more of traffic lights, traffic signs, other vehicles headlights, other vehicles backlights. Information about tracked light source detections is processed to time filter parts of the images according to the invention.

The first basic embodiment invention addresses the problem with flicker locally at the source. I.e. it can reduce flicker at the actual traffic light or traffic sign at day and night time, and solves the problem with flickering video for e.g. Event Data Recording (EDR), dashcam and display applications.

Preferably, the data processing unit is adapted to blend a first image region around a detected light source in said captured current image with a corresponding second image region in said at least one captured earlier image. More preferably, the first image region and the second image region are blended together with first and second weights.

According to an embodiment of the invention, an average image region of said first and said second image regions is calculated and blended into (over) the captured current image in the first image region, yielding a flicker-mitigated current image. Taking the average as described above corresponds to blending the first and second image regions together with equal first and second weights.

Other blending schemes can be established in the processing device. In some embodiments, the first image region and the second image region are blended together with different first and second weights.

In still another embodiment of the invention, the first and second weights vary within the first and second image regions. For example, the first and second weights may vary monotonically from a center to an edge of the first and second image regions. E.g. 50% blending (weighting) of time frame N and time frame N+1 at the center of the ROI of the light source (first and second image regions), and then gradually going to 100% weight on time frame N+1 at the edge of the ROI (first and second image regions).

All solutions described above can be readily generalized to more than two captured images corresponding to different time frames (captured current image and two or more captured earlier images).

In some of the above embodiments, the first and second image regions are blended together statistically, for example by taking averages, or weighted averages.

Alternatively, an image region where a light source is visible can be blended over the corresponding image region in the cap-current image where the light source is not visible, or barely visible, due to light source flickering, resulting in a flicker mitigated current image where the light source is better visible than in the original captured current image. Preferably, in order to find an image region where a light source is visible, the flicker mitigation software module may comprise a brightness/color detector capable of determining which of the first image region or the second image region has a higher brightness and/or a pre-defined color. This may then be taken as the true image region and blended over the first image region of the captured current image. If for example a traffic light is considered, and the brightness/color detector detects that an image region around the traffic light is dark in frame N and bright and/or red or orange or green in frame N+1, it determines that frame N+1 is correct (while frame N is discarded as belonging to an off phase of the LED pulse). The image region corresponding to frame N+1 may then be blended over the corresponding image region of the captured current frame (or the captured current frame may be left as it is, if the current frame is N+1).

As described above, a simple but effective first basic embodiment is to time filter information from two (or more) images. This can preferably be done according to the following scheme:

Find light source (e.g. traffic light) in time frame N. Find the same light source in time frame N+1. Take the region of interest (ROI) of the light source from frame N, and resample (blend) the ROI to the size of the light source ROI in frame N+1. Finally, let the output image be equal to frame N+1, except at light source ROI (i.e., where are detections). At the detected ROI (light source ROI), make the output image an average of frame N+1 and the resampled ROI (blending).

The processing unit preferably comprises a light source tracker adapted to track a detected light source over several image frames. The light source tracker is preferably adapted to predict the position of a detected light source in a future image frame. In other words, light source prediction is preferably provided in the tracking of traffic lights. E.g. based on detections in e.g. frames N−2, N−1, and N the light source tracker can predict where the traffic light will be in frame N+1. This will reduce the latency of creating the output image since there is no need to wait for the detection in frame N+1. Light source prediction can also be done using optical flow information provided by an optical flow estimator in the processing device.

Augmented reality applications where the live camera image is displayed for the driver in the vehicle can be more demanding with respect to flicker mitigation than e.g. Event Data Recording (EDR), dashcam and display applications, especially in a city with flickering street lights at night time where most of the illumination of the scene is flickering.

In order to cope with such more demanding applications, according to a second basic embodiment of the invention, the flicker mitigation software module is adapted to calculate a spatially low pass filtered difference image between said captured current image and said captured earlier image. Preferably, the flicker mitigation software module is adapted to compensate the current image used for display on the basis of said difference image.

Preferably, the flicker mitigation software module is adapted to calculate a spatially low pass filtered difference image between a specific color intensity of said captured current image and said captured earlier image. The specific color used for the calculation of the difference image according to the second basic embodiment advantageously correlates with the color of light sources in the dark, like green or yellow.

In a preferred embodiment, a spatially low pass filtered difference image between a green pixel intensity of said captured current image and said captured earlier image is calculated. The green pixel intensity is readily contained in the output signal of an RGB image sensor and can directly be processed without further calculations. Alternatively, a yellow pixel intensity of said captured current image and said captured earlier image could advantageously be considered in the case of a CYM image sensor.

The second basic embodiment eliminates much of the flickering/banding when flickering light sources illuminates the scene. It solves the problem with flickering/banding video from flickering illumination in e.g. night city scenarios.

The second basic embodiment works especially well for 50/60/100/120 Hz light sources where frame rate is 18.3 or 22 fps. These frame rates and flicker frequencies result in close to a 0.5 period phase shift (π phase shift) of the 100/120 Hz illumination between two consecutive image frames. Other less common flicker frequencies are also reduced.

Many automotive vision systems use different exposure settings, for example exposure setting A (ConA) and exposure setting B (ConB) which are alternated between every frame. As a practical example, ConA images are captured at 22 fps and ConB images are captured also at 22 fps. From this it is possible to create a 44 fps video stream. However, since the two con-texts use different gain and exposure time, first a conversion to a common output response curve needs to be done. This can e.g. be performed by having different gamma curves for ConA and ConB. For such conditions, 50/60/100/120 Hz flicker is best handled by handling ConA images and ConB images separately and performing flicker compensation according to the invention separately. E.g. ConA_{N} and ConA_{N+1} are used together, and then ConB_{N} and ConB_{N+1}, etc.

Generalizing the above, in case that more than one exposure settings is used in the imaging devices of the vision system, the flicker mitigation software module preferably performs the flicker mitigation calculation separately for each exposure setting. In the case of two exposure settings which are alternated every image frame (conA_{N}, conB_{N}, conA_{N+1}, conB_{N+1}, . . . ), flicker mitigation calculation is preferably performed on ConA_{N} and ConA_{N+1,} then ConB_{N} and ConB_{N+1}, etc.

In the following the invention shall be illustrated on the basis of preferred embodiments with reference to the accompanying drawings, wherein:

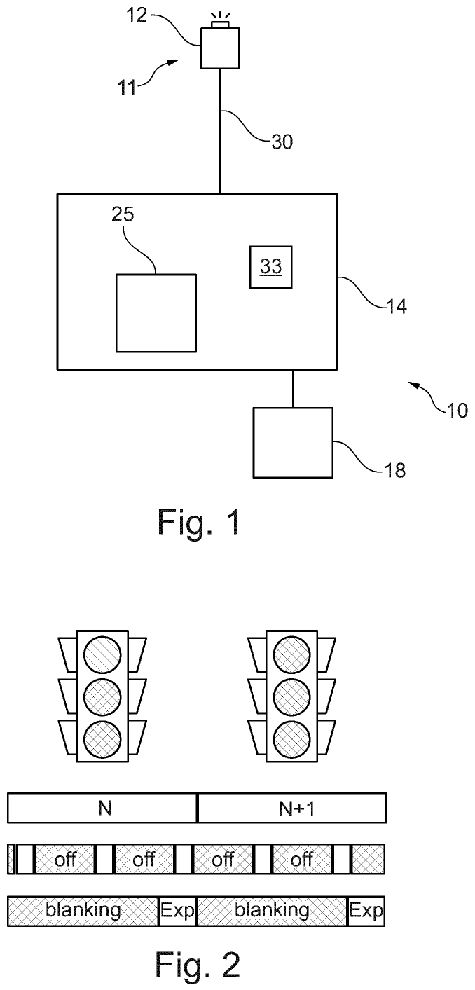

FIG. 1 shows a scheme of an on-board vision system;

FIG. 2 shows a drawing for illustrating the LED flicker effect in a video stream;

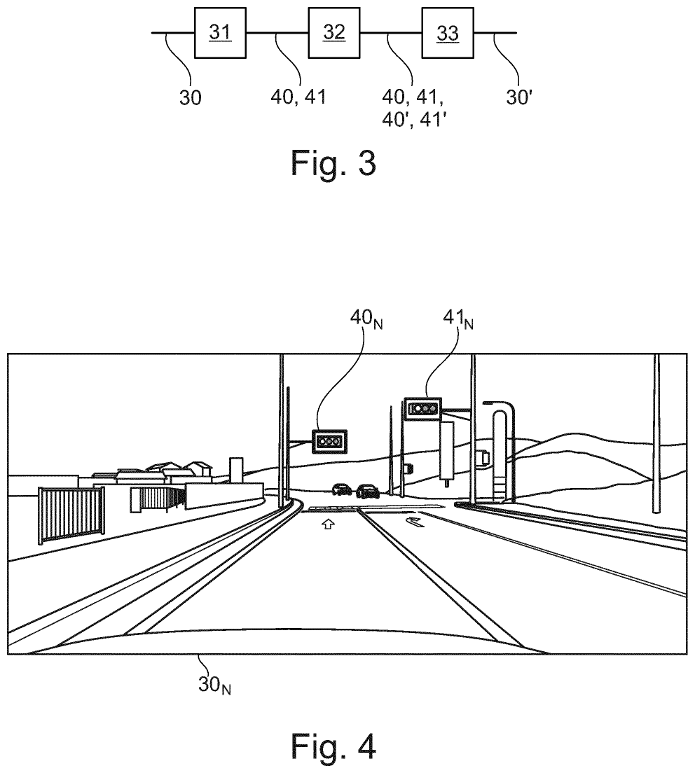

FIG. 3 shows a flow diagram illustrating image processing according to a first embodiment of the invention;

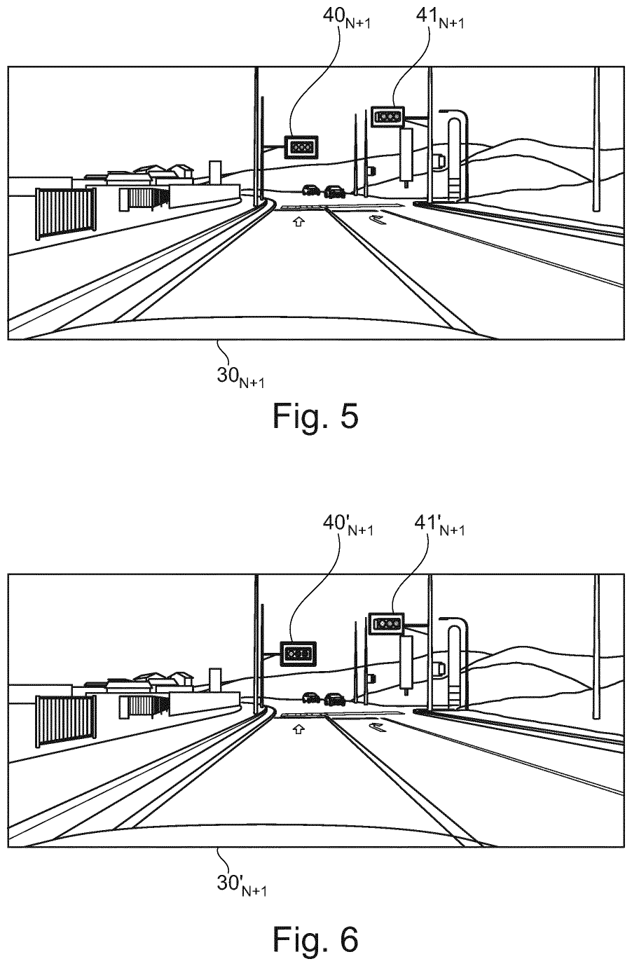

FIGS. 4, 5 show captured images corresponding to consecutive image frames;

FIG. 6 shows a flicker mitigated image;

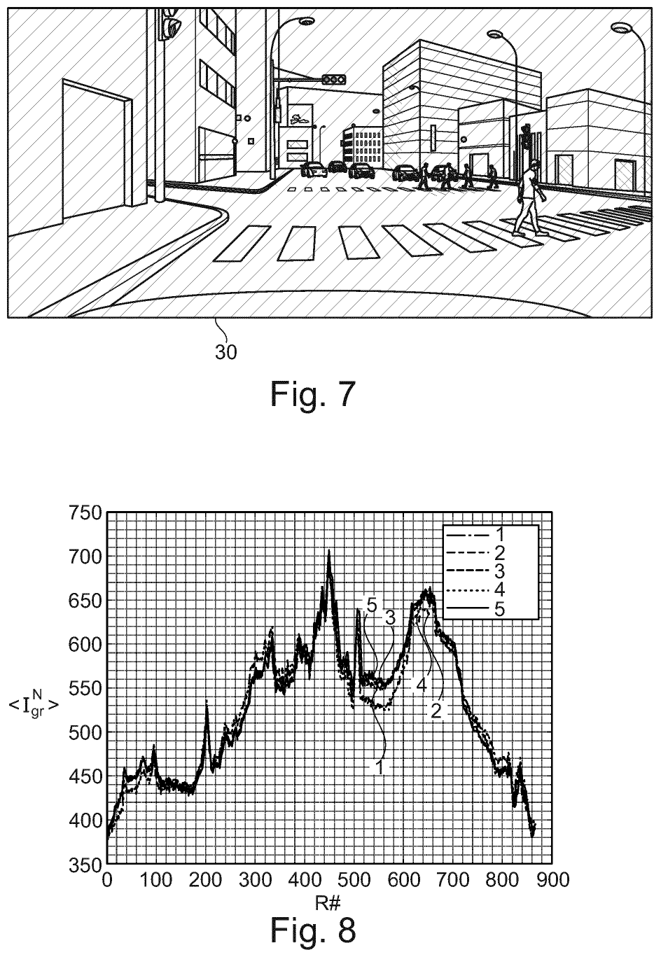

FIG. 7 shows a captured image at night time;

FIG. 8 shows a diagram with green pixel intensities averaged over an row for five consecutive image frames;

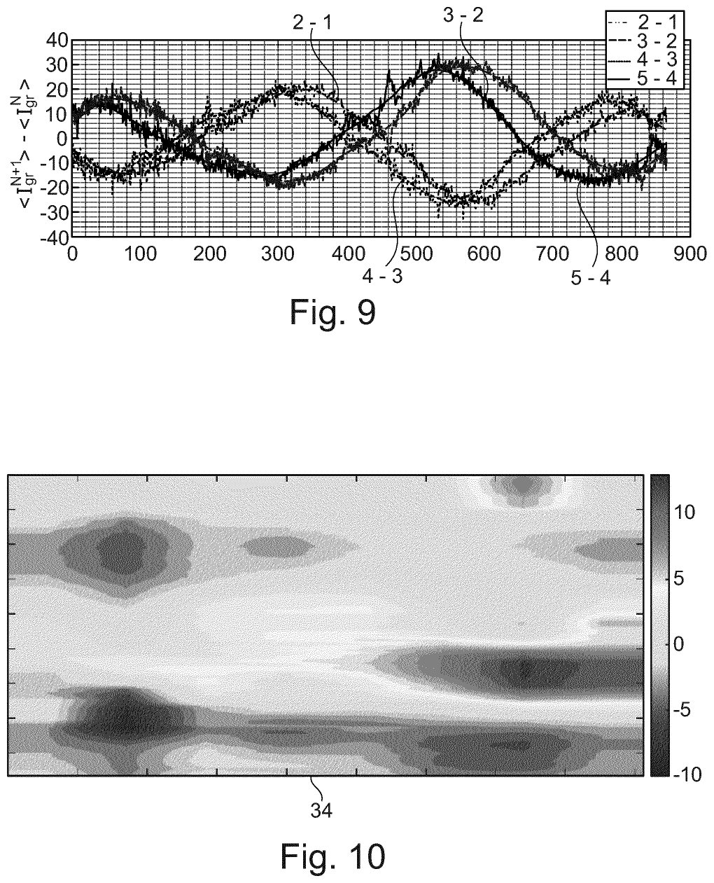

FIG. 9 shows a diagram with differences between any two consecutive curves of FIG. 8;

FIG. 10 shows a 2D spatially low pass filtered difference image between a captured current image and a captured earlier image; and

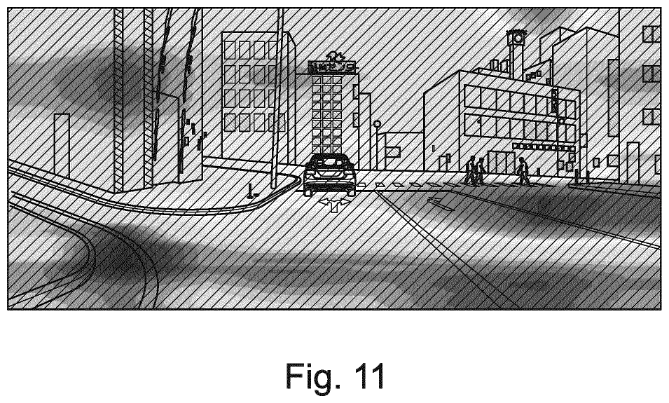

FIG. 11 shows a flicker mitigated current image generated by compensating the captured current image with the 2D spatially low pass filtered difference image of FIG. 11.

The on-board vision system 10 is mounted, or to be mounted, in or to a motor vehicle and comprises an imaging apparatus 11 for capturing images of a region surrounding the motor vehicle, for example a region in front of the motor vehicle. The imaging apparatus 11, or parts thereof, may be mounted for example behind the vehicle windscreen or windshield, in a vehicle headlight, and/or in the radiator grille. Preferably the imaging apparatus 11 comprises one or more optical imaging devices 12, in particular cameras, preferably operating in the visible wavelength range, or in the infrared wavelength range, or in both visible and infrared wavelength range. In some embodiments the imaging apparatus 11 comprises a plurality of imaging devices 12 in particular forming a stereo imaging apparatus 11. In other embodiments only one imaging device 12 forming a mono imaging apparatus 11 can be used. Each imaging device 12 preferably is a fixed-focus camera, where the focal length f of the lens objective is constant and cannot be varied.

The imaging apparatus 11 is coupled to an on-board data processing unit 14 (or electronic control unit, ECU) adapted to process the image data received from the imaging apparatus 11. The data processing unit 14 is preferably a digital device which is programmed or programmable and preferably comprises a microprocessor, a microcontroller, a digital signal processor (DSP), and/or a microprocessor part in a System-On-Chip (SoC) device, and preferably has access to, or comprises, a digital data memory 25. The data processing unit 14 may comprise a dedicated hardware device, like a Field Programmable Gate Array (FPGA), an Application Specific Integrated Circuit (ASIC), a Graphics Processing Unit (GPU) or an FPGA and/or ASIC and/or GPU part in a System-On-Chip (SoC) device, for performing certain functions, for example controlling the capture of images by the imaging apparatus 11, receiving the electrical signal containing the image information from the imaging apparatus 11, rectifying or warping pairs of left/right images into alignment and/or creating disparity or depth images. The data processing unit 14 may be connected to the imaging apparatus 11 via a separate cable or a vehicle data bus. In another embodiment the ECU and one or more of the imaging devices 12 can be integrated into a single unit, where a one box solution including the ECU and all imaging devices 12 can be preferred. All steps from imaging, image processing to possible activation or control of a safety device 18 are performed automatically and continuously during driving in real time.

Image and data processing carried out in the data processing unit 14 advantageously comprises identifying and preferably also classifying possible objects (object candidates) in front of the motor vehicle, such as pedestrians, other vehicles, bi-cyclists and/or large animals, tracking over time the position of objects or object candidates identified in the captured images, and activating or controlling at least one safety device 18 depending on an estimation performed with respect to a tracked object, for example on an estimated collision probability.

The safety device 18 may comprise at least one active safety device and/or at least one passive safety device. In particular, the safety device 18 may comprise one or more of: at least one safety belt tensioner, at least one passenger air-bag, one or more restraint systems such as occupant airbags, a hood lifter, an electronic stability system, at least one dynamic vehicle control system, such as a brake control system and/or a steering control system, a speed control system; a display device to display information relating to a detected object; a warning device adapted to provide a warning to a driver by suitable optical, acoustical and/or haptic warning signals.

The invention is applicable to autonomous driving, where the ego vehicle is an autonomous vehicle adapted to drive partly or fully autonomously or automatically, and driving actions of the driver are partially and/or completely replaced or executed by the ego vehicle.

The problem underlying the present invention is illustrated in FIG. 2, which has been taken from B. Deegan, “LED flicker: root cause, impact and measurement for automotive imaging applications”, IS&T Electronic Imaging, Autonomous Vehicles and Machines 2018, p. 146-1 to 146-6. It displays an LED traffic light signalling red in two consecutive time frames N and N+1. The LED pulse scheme of the traffic light is shown in the second line under the traffic lights. In the last line, the exposure scheme of the imaging device 12 (more specifically, of the imaging sensor in the camera 12) is shown. In time frame N, the exposure time of the imaging sensor overlaps the LED pulse ON, such that the red light is visible in the image of time frame N. However, in time frame N+1, there is no overlap between the exposure time and the LED pulse ON, since the exposure time lies completely in the blanking interval of the imaging sensor. Consequently, time frame N+1 completely misses the LED pulses, and the traffic light appears completely OFF in time frame N+1, which causes an unwanted flicker effect in the video stream.

On order to solve the above problem, the data processing unit 14 comprises a flicker mitigation software module 20 adapted to generate a flicker mitigated current image for a current image frame by filter processing involving a captured current image corresponding to the current image frame and at least one captured earlier image corresponding to an earlier image frame. This is explained in the following for two basic embodiments of the invention. The flicker mitigation software module 20 has access to the data memory 25 where the one or more earlier images needed for the flicker mitigation are stored for use in the current time frame processing.

A first basic embodiment of the invention is explained with reference to FIGS. 3 to 6. In FIG. 3 image processing in the data processing unit 14 is illustrated in a flow diagram. Images 30 captured by the imaging apparatus is input to a light source detector 31 which is adapted to detect light sources, like traffic lights, traffic signs and/or other vehicles headlights or backlights in the images 30.

A simple practical example of two images 30_{N}, 30_{N+1} corresponding to consecutive time frames N and N+1 is shown in FIGS. 4 and 5, where N+1 is the current image frame, such that FIG. 5 shows the captured current image 30_{N+1}, and N is the last time frame before the current time frame, such that FIG. 4 shows the captured earlier image 30_{N}. Two traffic lights for a level crossing are visible, where the light source detector 31 is adapted to detect these traffic lights and output a so-called bounding box 40_{N}, 41_{N} (40_{N+1}, 41_{N+1}) for each detected light source or traffic light, which limits a small, usually rectangular image region around and including said detected light sources. The image region within a bounding box 40_{N}, 41_{N} (40_{N+1}, 41_{N+1}) defines the corresponding region-of-interest (ROI) of the corresponding traffic light in the flicker mitigation processing. In the following, the terms “bounding box” and “ROI” are used synonymously, where it should be understood that an ROI is actually an image region (or an image patch, i.e. an image content) within boundaries defined by the bounding box.

By comparing FIGS. 4 and 5, it is evident that FIG. 4 corresponds to an ON phase of the LED light pulse of the traffic lights, such that the traffic lights are brightly visible, while FIG. 5 corresponds to an OFF phase of the LED light pulse, such that the green traffic lights are barely visible in the captured current image 30_{N+1} shown in FIG. 5, although the traffic lights are actually on (green lights). This leads to a disadvantageous flicker in a video comprising the time frames . . . , N, N+1, . . . .

The light source detector 31 outputs information relating to the bounding boxes 40, 41, like position and size of these, and the image patches (ROIs) limited by the bounding boxes, to an optional light source tracker 32. The light source tracker 32, if present, is adapted to track the detected light sources over several time frames, and to output corresponding bounding box information 40, 41. For example, FIG. 5 shows an image from the same imaging apparatus 11 as FIG. 4 but corresponding to the next image frames N+1. The light source tracker 32 is adapted to track the traffic lights of FIG. 4 also in the image of the consecutive image frame N+1 (FIG. 5) and determine corresponding bounding boxes 40_{N+1}, 41_{N+1} also in FIG. 5. Of course, detected light sources may be tracked over more than two consecutive image frames.

The light source detector 31 and the light source tracker 32 are software modules similar to conventional object detectors and trackers for detecting and tracking objects like for example other vehicles, pedestrians etc., and may be known per se.

All information on bounding boxes 40_{N}, 41_{N}, 40_{N+1}, 41_{N+1} of consecutive image frames N, N+1, . . . , are forwarded to a flicker mitigation software module 33. The flicker mitigation software module 33 takes the region of interest (ROI) of the traffic light from time frame N (image region in bounding box 40_{N} and 41_{N}, respectively), and resamples the ROI of time frame N to the size of the traffic light ROI in the time frame N+1 (image region in bounding box 40_{N+1} and 41_{N+1}, respectively).

In one embodiment, the flicker mitigation software module 33 calculates an average ROI 40′_{N+1}, 41′_{N+1} from the resampled ROI of time frame N and the ROI of time frame N+1, where calculating an average ROI means calculating an average z value (RGB value, greyscale value or intensity value) of each pixel of the ROI. The flicker mitigation software module 33 then creates a flicker mitigated current image 30′_{N+1} by taking the captured current image 30_{N+1} everywhere outside the ROIs of detected light sources (here, everywhere outside the ROIs 40_{N+1}, 41_{N+1}); while filling in the averaged ROIs 40′_{N+1}, 41′_{N+1} into the bounding boxes of the of the detected light sources.

As a result, the flicker mitigated current image 30′_{N+1} shown in FIG. 6 is obtained, where the traffic lights are much better visible than in the captured (non-flicker mitigated) current image 30′_{N+1} shown in FIG. 5, such that flicker in a video comprising the time frames . . . , N, N+1, . . . can be strongly reduced. Flicker mitigates images 30′ are output by said flicker mitigation software module 33, see FIG. 3.

In another embodiment, the flicker mitigation software module 33 comprises a brightness and/or color detector which is adapted to detect the brightness and/or color (like green/orange/red in the case of traffic lights) of the detected light sources in the ROIs 40_{N}, 41_{N}, 40_{N+1}, 41_{N+1}, and to decide which of the ROIs 40_{N}, 41_{N}, 40_{N+1}, 41_{N+1} is preferable. In the example of FIGS. 4 and 5, the brightness and/or color detector would be able to detect that the ROIs 40_{N}, 41_{N} are bright and green (corresponding to green traffic light), while the ROIs 40_{N+1}, 41_{N+1} are essentially dark. Therefore, the brightness and/or color detector decides that the ROIs 40_{N}, 41_{N} are preferable over the ROIs 40_{N+1}, 41_{N+1}. The flicker mitigation software module 33 then creates a flicker mitigated current image 30′_{N+1} by taking the captured current image 30_{N+1} everywhere outside the ROIs of detected light sources (here, everywhere outside the ROIs 40_{N+1}, 41_{N+1}); while filling in the brighter and/or colored, and therefore preferred, ROIs 40_{N}, 41_{N} into the bounding boxes of the of the detected light sources. As a result, a flicker mitigated current image is obtained, where the traffic lights are very well visible (like in FIG. 4), such that flicker in a video comprising the time frames . . . , N, N+1, . . . can be strongly reduced or even eliminated.

In a second basic embodiment of the invention, the flicker mitigation software module 33 is adapted to calculate a spatially low pass filtered difference image between a captured current image 30_{N+1} and a captured earlier image 30_{N}; and preferably to compensate the captured current image 30_{N+1} on the basis of the calculated spatially low pass filtered difference image.

The second basic embodiment of the invention is described in the following with reference to FIGS. 7 to 11.

FIG. 7 shows a captured image 30 of a city scene with a fairly uniform illumination of the scene. As an example, it can be assumed that the street lights are powered by 50 Hz.

Before coming to the general case, a simple example with a fairly uniform illumination of the scene will be investigated for a better understanding. Here, the flicker mitigation software module 33 is adapted to calculate the mean (average) of the green pixel intensity (in an RGB color sensor) over every image row of captured images 30 like the one shown in FIG. 7. The result is shown in FIG. 8 for five consecutive image or time frames (frames 1-5), where the y axis denotes the green pixel (intensity) value intensity averaged over an image row, for example as given by the Least Significant Bit (LSB), and the x-axis denotes the row number. Since the streetlights in the scene in this example flicker with 100 Hz (50 Hz net frequency), similar row mean intensity values are obtained for all the odd frames (1, 3, 5 in the plot) and other similar row mean intensity values for the even frames (2 and 4 in the plot). This is expected due to the relationship between the net frequency and the camera 12 frequency.

The flicker mitigation software module 33 is adapted to calculate the differences between the row mean intensity values (row mean differences) for consecutive frames. The corresponding differences between the row mean intensity values of image frames 1 and 2, frames 2 and 3, frames 3 and 4, and frames 4 and 5 of FIG. 8 are shown in FIG. 9, where the y axis denotes the difference of the curves of FIG. 8 for two consecutive frames, and the x axis again denotes the row number. By low pass filtering the row mean differences, the solid curves in FIG. 9 are obtained. Here, a clear pattern due to the camera frame rate and rolling shutter line time compared to the net frequency driving the street lights is visible.

Generalizing the above, the following compensation scheme performed in the flicker mitigation software module 33 is suited for removing the flicker/banding in a perfectly even illuminated scene:
Calculate the green pixel intensity averaged over an image row (row mean) for consecutive frames N+1 and N;
Calculate the row mean difference between frame N+1 and frame N;
spatially low pass filter the row mean difference;
compensate frame N+1 with half of the spatially low pass filtered row mean difference.

In reality there can be much more varying illumination in a scene. Therefore, instead of calculating one compensation value per row (1D compensation), the flicker mitigation software module 33 should preferably be adapted to perform a 2D compensation. In a similar fashion like above, green pixel intensity differences between two frames are calculated by the flicker mitigation software module 33 in a 2D fashion (instead of 1D). This can be done in several ways, e.g.:
A. Calculate a complete 2D difference image from image N and N+1. Spatially low pass filter it. An example of a complete low pass filtered 2D difference image for the scene of FIG. 7 is shown in FIG. 10. Use the low pass filtered complete 2D difference image for compensation. An example of the compensated current image for the scene of FIG. 7, where the compensation has been performed on the basis of the complete low pass filtered 2D difference, is shown in FIG. 1. In the scene of FIG. 11, there are strong down-ward facing streetlights giving local flicker in the scene without flicker mitigation.
B. Divide the image into sub-regions (e.g. 64 px×32 px sub-regions) and calculate pixel mean values for these regions. Calculate a (64×32) px difference sub-image between the two sub-images corresponding to the sub-regions using the regional averages. Optionally perform spatial low pass filtering. Perform compensation of the captured current image N+1 by interpolating the small (64×32) px difference image.

When the vehicle is moving, subsequent images N and N+1 capture a slightly different view of the environment since the camera has moved relative to the environment. This can preferably be compensated by resampling image N before calculating the difference image. This will be more computationally efficient when using approach B above compared to approach A, since a lower resolution image, the sub-region image, needs to be resampled compared to resampling the full resolution image.

The pixel resampling locations can be calculated from, e.g., optical flow or from a model of the environment, or from a combination thereof. The model would use camera calibration and the vehicle movement. Vehicle movement can be known from vehicle signals like speed and yaw rate, or be calculated from visual odometry. The most simple model of the environment is a flat world model, where the ground is flat and nothing exists above the ground. Several models could be used, e.g. a tunnel model can be used when driving in a tunnel.

1-15. (canceled)

16. A vision system for a motor vehicle, comprising:
a memory; and
a processor communicatively coupled to the memory and configured to:
receive, from a camera, a first image frame and a second image frame;
process the first image frame and the second image frame to detect objects within the first image frame and the second image frame; and
generate a flicker mitigated current image based on filter processing the first image frame and the second image frame.

17. The vision system of claim 16, wherein the processor is configured to:
detect a light source in the first image frame and the second image frame; and
time filter a region around the detected light source in the first image frame and the second image frame.

18. The vision system of claim 17, wherein the processor is configured to blend a first image region around the detected light source in the first image frame with a corresponding second image region in the second image frame.

19. The vision system of claim 18, wherein the processor is configured to blend the first image region with the second image region based on first and second weights.

20. The vision system of claim 19, wherein the first and second weights vary within the first and second image regions.

21. The vision system of claim 20, wherein the first and second weights vary monotonically from a center to an edge of the first and second image regions.

22. The vision system of claim 18, wherein the processor is configured to determine which of the first image region and the second image region has at least one of a higher brightness and pre-defined color.

23. The vision system of claim 17, wherein the processor is configured to blend the second image region around the detected light source in the second image frame over the first image region in the first image frame, wherein the detected light source is visible in the second image frame and not visible in the first image frame.

24. The vision system of claim 17, wherein the processor is configured to track the detected light source over a plurality of image frames comprising the first image frame and the second image frame.

25. The vision system of claim 17, wherein the processor is configured to predict the position of the detected light source in a future image frame.

26. The vision system of claim 16, wherein the processor is configured to:
calculate a spatially low pass filtered difference image between the first image frame and the second image frame; and
compensate the first image frame based on the spatially low pass filtered difference image.

27. The vision system of claim 26, wherein the processor is configured to calculate the spatially low pass filtered difference image based on a color intensity of the first image frame and the second image frame.

28. The vision system of claim 27, wherein the processor is configured to calculate the spatially low pass filtered difference image between a green pixel intensity of the first image frame and a green pixel intensity of the second image frame.

29. The vision system of claim 16, wherein the camera is configured to capture a plurality of image frames comprising the first image frame and the second image frame at a plurality of exposure settings, and wherein the processor is configured to generate flicker mitigated images from the captured images based on the plurality of exposure settings, the flicker mitigated images comprising the flicker mitigated current image.

30. The vision system of claim 16, wherein the processor is configured to resample the second image frame before the filter processing to compensate for movement of the motor vehicle from a first time associated with the second image frame to a second time associated with the first image frame.

31. The vision system of claim 16, comprising the camera.

32. A method by at least one processor, the method comprising:
receiving, from a camera, a first image frame and a second image frame;
processing the first image frame and the second image frame to detect objects within the first image frame and the second image frame; and
generating a flicker mitigated current image based on filter processing the first image frame and the second image frame.

33. The method of claim 32, comprising:
detecting a light source in the first image frame and the second image frame; and
time filtering a region around the detected light source in the first image frame and the second image frame.

34. The method of claim 33, comprising blending a first image region around the detected light source in the first image frame with a corresponding second image region in the second image frame.

35. The method of claim 34, comprising blending the first image region with the second image region based on first and second weights.
